(19) United States
(12) Patent Application Publication
(10) Pub. No.: US 2013/0191636 A1
(43) Pub. Date: Jul. 25, 2013

(54) STORAGE DEVICE, HOST DEVICE, AND INFORMATION PROCESSING METHOD

(71) Applicant: Yasuto ARAMAKI, Kawasaki-shi (JP)

(72) Inventor: Yasuto ARAMAKI, Kawasaki-shi (JP)

(73) Assignee: KABUSHIKI KAISHA TOSHIBA, Tokyo (JP)

(21) Appl. No.: 13/517,743

(22) Filed: Jun. 14, 2012

(30) Foreign Application Priority Data
Jan. 25, 2012 (JP) 2012-013135

(51) Int. Cl. H04L 9/32

(52) U.S. Cl. 713/168

(57) ABSTRACT

A storage device includes a storage module, an authentication process execution module, an encryption processor and a security setting module. The storage module stores an encryption key, a flag indicating whether the encryption key can be used, a password used for authentication associated with the encryption key and the flag, and user data. The authentication process execution module uses a password to authenticate a connected host device. The encryption processor uses an encryption key stored being associated with a flag indicating permission to use the encryption key in accordance with an instruction from the host device, and encrypts user data received from the host device or decrypts the user data stored in the storage module. On encryption or decryption, the security setting module changes the setting of a flag stored being associated with the encryption key used for the encryption or the decryption.

### CROSS-REFERENCE TO RELATED APPLICATIONS

This application is based upon and claims the benefit of priority from Japanese Patent Application No. 2012-013135, filed on Jan. 25, 2012; the entire contents of which are incorporated herein by reference.

### FIELD

Embodiments described herein relate generally to a storage device, a host device and an information processing method.

### BACKGROUND

As a storage device such as a hard disk drive and an SSD (Solid State Drive), there exists a storage device that has a function of storing data after encryption to prevent a leak of the stored information. In such a storage device, an encryption key is used to perform encryption at the time of writing data and decryption at the time of reading data.

Moreover, there exists a storage device that divides a storage area into a plurality of areas, and uses a plurality of encryption keys by allocating an encryption key individually to each of the plurality of areas.

However, if a storage area is divided into a plurality of areas and a plurality of encryption keys is used, the problem described below arises.

In other words, upon dividing the storage area into the plurality of areas, each area obtained by the division (hereinafter referred to as a “sub-area” for convenience of description) needs to preestimate the number of files and their file sizes, which are expected to be stored in a sub-area, and designate a sub-area with the size having sufficient space to a certain degree. Therefore, there may remain many sectors that are not used and go to waste in each sub-area. This is because one application data (file) cannot be stored extending over the plurality of sub-areas. The number of wasted sectors increases as the number of set sub-areas (the number of division of the storage area) increases, and efficiency in use of the storage area decreases.

Moreover, data stored in an encrypted state can be securely erased by changing an encryption key used upon encryption (in other words, an encryption key used upon decryption). However, the encryption key is allocated to each sub-area; accordingly, if there exists a plurality of files in the same sub-area, it is only possible to simultaneously erase all the files in the same sub-area, and it is not possible to erase a specific file. It is possible to securely erase one file by overwriting a file desired to be erased with a random number or the like; however, some files such as video files may exceed several gigabytes as one file, and erasure by overwriting takes several minutes or more, and therefore in reality is difficult.

Moreover, in the case where storage devices are SSDs using a storage media with a short life (a limit of the number of writes) such as a NAND flash memory, and the like, some storage devices successively write to different sectors to last the life of the media even if receiving a write instruction that designates the same logical block address (LBA) from the host. In this case, even if the file is overwritten to be erased, what is erased is a sector that was written last, and the trace of the data remains on the sectors used in the past.

### BRIEF DESCRIPTION OF THE DRAWINGS

FIG. 1 is a view illustrating a configuration example of an information processing system including a storage device according to an embodiment;

FIG. 2 is a view illustrating an example of a detailed functional block configuration of the storage device;

FIG. 3 is a view illustrating an example of a detailed functional block configuration of a host device;

FIG. 4 is a view illustrating a configuration example of a key table;

FIG. 5 is a flowchart illustrating an example of a procedure for changing a password registered in the key table;

FIG. 6 is a flowchart illustrating an example of a procedure for changing the setting of a flag in the key table;

FIG. 7 is a view illustrating a configuration example of a write command;

FIG. 8 is a flowchart illustrating an example of a file write procedure;

FIG. 9 is a flowchart illustrating an example of a file read procedure;

FIG. 10 is a view illustrating an example of a method of using a storage area;

FIG. 11 is a flowchart illustrating an example of a procedure for changing an encryption key registered in the key table;

FIG. 12 is a view illustrating an example of an operation of moving a file in a storage media of the storage device; and

FIG. 13 is a view illustrating an example of a file erasure operation.

### DETAILED DESCRIPTION

According to one embodiment of the present invention, a storage device includes a storage module, an authentication process execution module, an encryption processing module, and a security setting module. The storage module stores an encryption key, a flag indicating whether or not the encryption key can be used, and a password used for authentication while associating them with each other, and stores user data. Moreover, the authentication process execution module uses the password to authenticate a connected host device. The encryption processing module uses an encryption key stored in association with a flag indicating permission to use the encryption key in accordance with an instruction from the host device that was successful in the authentication, and performs an encryption process on user data received from the host device or a decryption process on the user data stored in the storage module. Upon performing the encryption process or the decryption process, the security setting module changes the setting of the flag stored in association with the encryption key used for the encryption process or the decryption process.

Hereinafter, a storage device, a host device and an information processing method according to embodiments will be described in detail with reference to the accompanying drawings. However, the present invention is not limited to the embodiments.

### First Embodiment

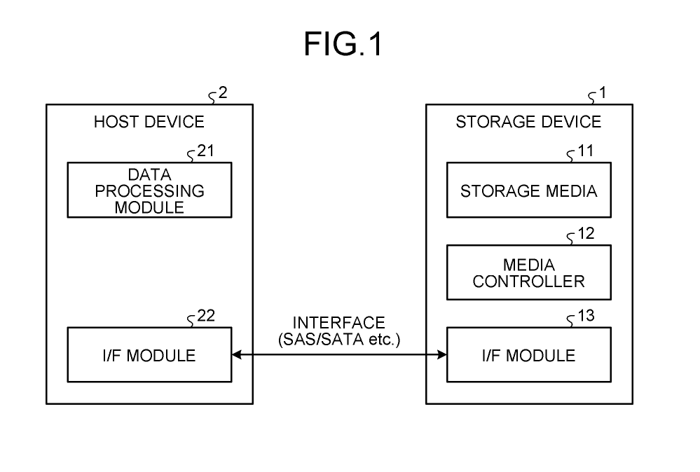

FIG. 1 is a view illustrating a configuration example of an information processing system including a storage device according to an embodiment. As illustrated, the information processing system of the embodiment includes a storage device 1 that stores various types of information, and a host device 2 that handles information to be stored in the storage device 1. The storage device 1 includes a storage media 11 that is a storage module for storing various types of information, a media controller 12 that performs a process of writing various types of information (data) to the storage media 11 and a process of reading various types of information from the storage media 11, and an I/F module 13 that is a physical interface. The host device 2 includes a data processing module 21 that instructs the storage device 1 to write and read data and outputs data to be stored, and an I/F module 22 that is a physical interface. The I/F module 13 of the storage device 1 and the I/F module 22 of the host device 2 transmit and receive data in a system in conformity with a standard such as SAS (Serial Attached SCSI (Small Computer System Interface)) and SATA (Serial Advanced Technology Attachment).

In the information processing system with a configuration shown in FIG. 1, when outputting data to be stored in the storage device 1 (data to be written to the storage media 11) to the storage device 1, the host device 2 instructs whether to store the data after encryption. The storage device 1 receives the data from the host device 2, and then checks the instruction content. If instructed to perform encryption, the storage device 1 stores the received data in the storage media 11 after encryption. Moreover, if instructed by the host device 2 to output (read) data stored in the storage media 11 and data corresponding to the instruction content is stored in an encrypted state, the storage device 1 outputs the data to the host device 2 after decryption. The media controller 12 encrypts and decrypts the data.

For simplification purposes, a description will be given on a case where the host device 2 accesses the storage device 1; however, a system may be configured such that a host device other than the host device 2 can access the storage device 1, too. In other words, it may be configured to share the storage device 1 among a plurality of host devices.

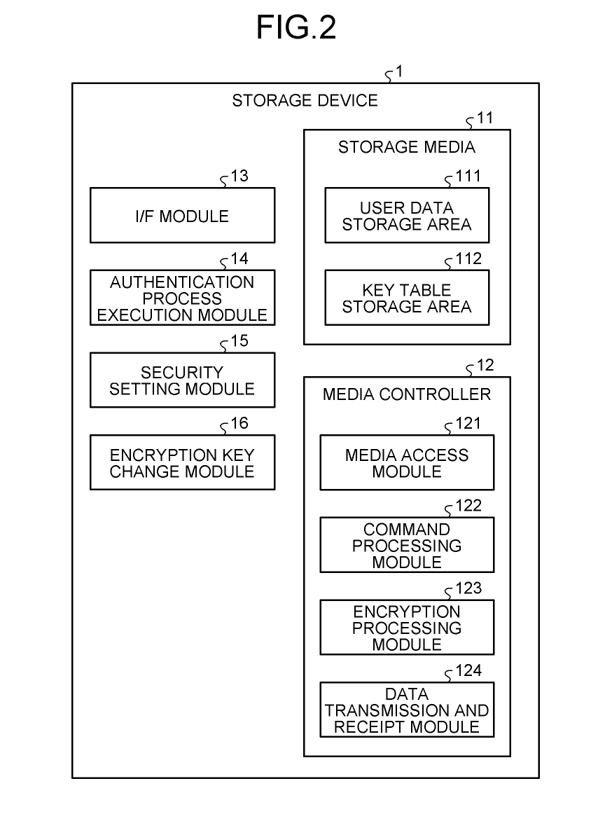

FIG. 2 is a view illustrating an example of a detailed functional block configuration of the storage device 1. The storage device 1 includes an authentication process execution module 14, a security setting module 15 and an encryption key change module 16 in addition to the storage media 11, the media controller 12 and the I/F module 13, which are shown in FIG. 1. Moreover, the storage media 11 has a user data storage area 111 and a key table storage area 112. The media controller 12 has a media access module 121, a command processing module 122, an encryption processing module 123 and a data transmission and receipt module 124.

The authentication process execution module 14 executes a process of judging whether to grant an access (an authentication process) if an external device such as the host device 2 requests an access. The security setting module 15 changes a password to be referred to in the authentication process by the authentication process execution module 14 in response to an instruction from the external device to which access has been granted. The encryption key change module 16 changes an encryption key used for the file encryption and decryption processes by the media controller 12 in response to an instruction from the host device 2.

The user data storage area 111 in the storage media 11 is an area for storing a file that is user data handled by the host device 2, and the key table storage area 112 is an area for storing a table (key table) where information on encryption keys used for the file encryption and decryption processes by the media controller 12, and the like are registered.

In the media controller 12, the media access module 121 executes the process of writing a file to the storage media 11 and the process of reading a file from the storage media 11. The command processing module 122 analyzes the content of a command (a file write instruction command, a file read instruction command, and the like) transmitted from the host device 2. The encryption processing module 123 executes the file encryption and decryption processes. The data transmission and receipt module 124 transmits and receives a file to and from the host device 2 via the I/F module 13.

The storage device 1 is a hard disk drive or an SSD. Moreover, the storage device 1 may be a USB memory or various kinds of memory cards.

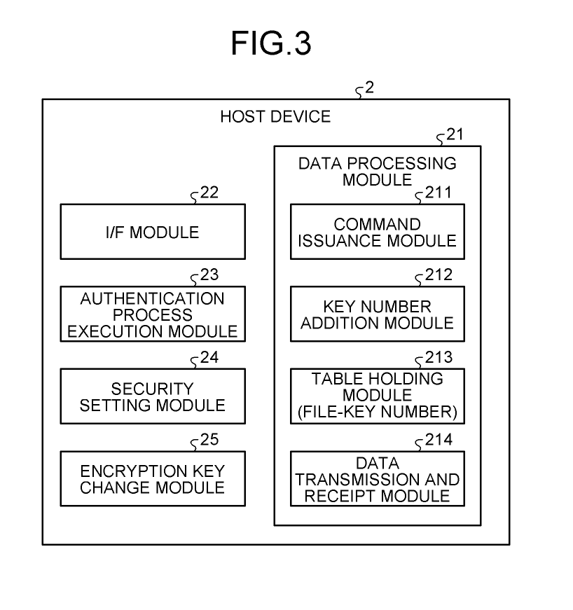

FIG. 3 is a view illustrating an example of a detailed functional block configuration of the host device 2. The host device 2 includes an authentication process execution module 23, a security setting module 24 and an encryption key change module 25 in addition to the data processing module 21 and the I/F module 22, which are shown in FIG. 1. Moreover, the data processing module 21 has a command issuance module 211, a key number addition module 212, a table holding module 213, and a data transmission and receipt module 214.

The authentication process execution module 23 executes the authentication process necessary for an access to the storage device 1. Specifically, the authentication process execution module 23 acquires and holds a password from a user of the host device, and outputs the held password to the storage device 1 to request an access if an access to the storage device 1 becomes necessary. The security setting module 24 accesses the storage device 1 at the request of the user to change the password to be referred to at the time of next and subsequent access (authentication process execution). The encryption key change module 25 accesses the storage device 1 at the request of the user to change an encryption key used for the file encryption and decryption processes.

In the data processing module 21, the command issuance module 211 issues various commands to be transmitted to the storage device 1, in other words, a write command to instruct file writing, a read command to instruct file reading, a command to instruct a change of a password or an encryption key, and the like. The key number addition module 212 adds a key number that indicates an encryption key used for the encryption and decryption processes to the write command and the read command among the commands issued by the command issuance module 211, as necessary. The table holding module 213 holds a table that indicates a corresponding relationship between a key number added to the write command and a file instructed to be written by the write command. The table is referred to when a key number added to the read command is determined. The data transmission and receipt module 214 transmits and receives a file to and from the storage device 1 via the I/F module 22.

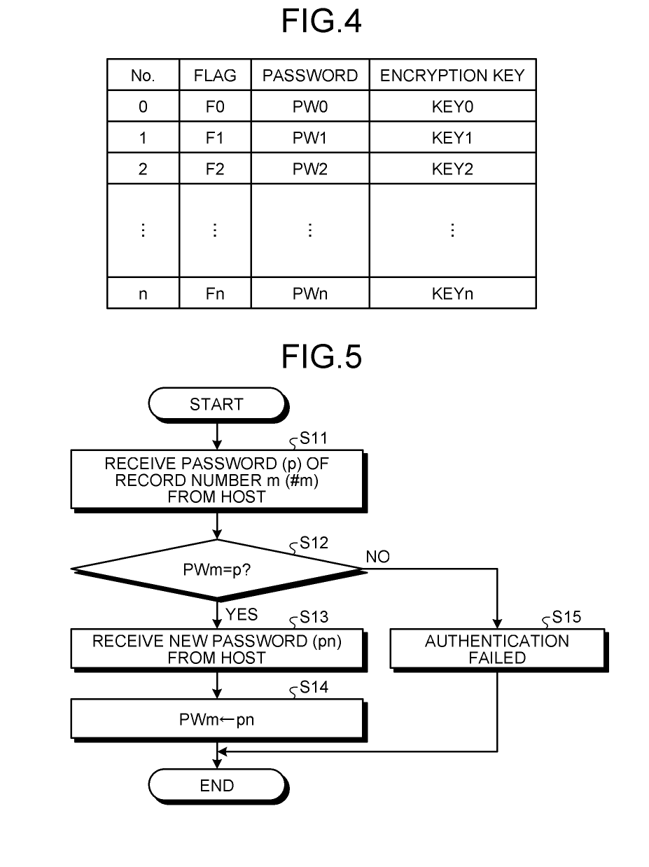

A description will hereinafter be given on the operation of the information processing system according to the embodiment. Here, a description will be given on the key table that is the information referred to when the storage device 1 executes various operations. FIG. 4 is a view illustrating a configuration example of the key table. The key table shown in FIG. 4 is stored in the key table storage area in the storage media 11 included in the storage device 1. Each record (row data) of the key table includes a “number (No.),” a “flag,” a “password,” and an “encryption key.”

The “number” is an identification number of a record (hereinafter referred to as record number). A maximum of n number of records can be registered in the key table. The “flag” is information that indicates whether or not an encryption key, “KEYx” (x=0, 1, 2, . . . , n), registered in the same record can be used. For example, the encryption key cannot be used if “Fx=0,” and can be used if “Fx=1.” The encryption key “KEYx” cannot be used in the initial state where “Fx=0.” Encryption keys may be separated into two of encryption keys for media writing (FWx) and encryption keys for media reading (FRx) to be managed/operated. The “password” is used for authentication of the host device that requests a change in information registered in the same record. If the host device 2 is successful in authentication that used a password “PWx” registered in a record of “No.x,” changes in a flag “Fx,” the password “PWx,” and the encryption key “KEYx” are permitted. A known value is set for each password as an initial value. The “encryption key” is the information used for the file encryption process and decryption of the encrypted file. In the embodiment, the storage device 1 itself sets a random number value for the value of “KEYx” in response to an instruction from the host device 2. The set random number value (encryption key) is not notified to the host device 2 (the host device 2 does not recognize an encryption key used by the storage device 1). The system may be one that the storage device 1 itself does not generate a random number to set it as an encryption key, but receives an encryption key from the host device 2. Moreover, PWx and KEYx may be scrambled by encryption or the like to keep the storage device 1 secure.

### <Password Setting (Change) Operation>

A description will be given on the operation of setting a password registered in the key table. FIG. 5 is a flowchart illustrating an example of a procedure for changing a password registered in a predetermined record in the key table shown in FIG. 4. FIG. 5 illustrates a processing procedure on the storage device 1 side. It is assumed that a password is preregistered in each record in the key table.

If a password registered in a record of a number m (m=0, 1, 2, . . . , n) is to be changed, the authentication process execution module 23 of the host device 2 firstly transmits the password corresponding to the record number m to the storage device 1, and makes a request to execute the authentication process for an access to the record of the number m (record #m). The password is, for example, previously acquired from the user and is held. It is also possible to acquire the password not in advance but when the user performs the operation of instructing an access to the record #m.

If receiving the password (p) corresponding to the record number m (#m) from the host device 2 (Step S11), the storage device 1 starts the authentication process. In other words, the authentication process execution module 14 of the storage device 1 checks whether or not a password PWm registered in the record #m agrees with the password p received in the above Step S11 (Step S12). If “PWm=p” (Step S12: Yes), the fact is notified to the host device 2 as authentication success. In the host device 2 that has received the notification that authentication was successful, the security setting module 24 transmits a new password pn to be registered in the record #m to the storage device 1. In the storage device 1 that has received the new password pn from the host device 2, the security setting module 15 replaces the password PWm registered in the record #m with the received password pn (Steps S13 and S14).

On the other hand, if the security setting module 15 judges that “PWm≠p” in the above Step S12 (Step S12: No), the operation is terminated as authentication failure (Step S15).

The host device 2 may not transmit a new password after authentication is successful, but may transmit a new password together with an existing password for authentication to update to the new password if authentication is successful.

### <Operation of Setting Encryption Key to Enable/Disable>

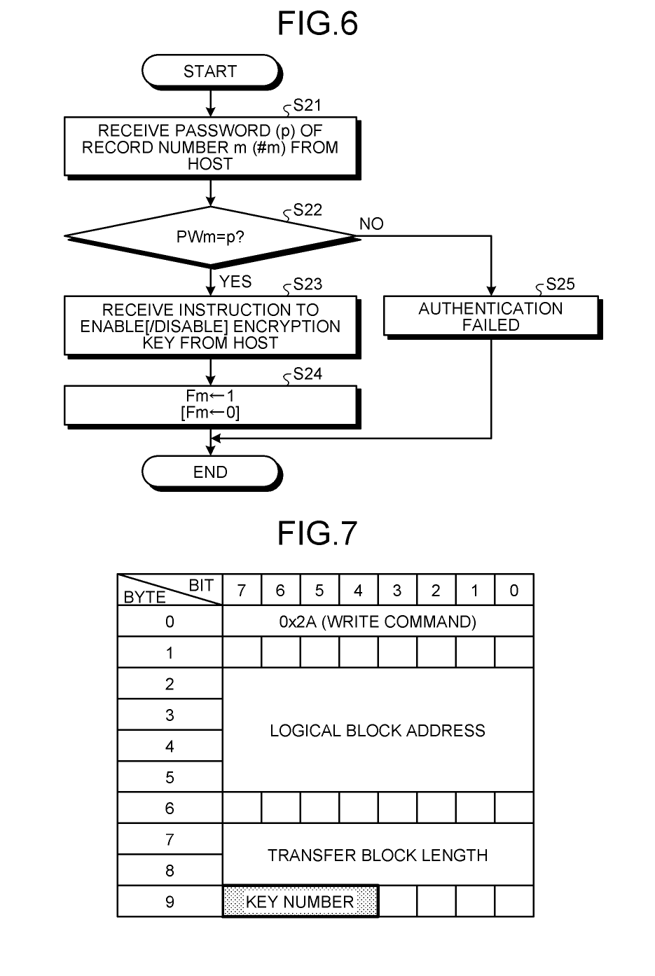

A description will be given on the operation of enabling (or disabling) an encryption key by changing the setting of a flag registered in the key table. FIG. 6 is a flowchart illustrating an example of a procedure for changing the setting of a flag included in a predetermined record in the key table shown in FIG. 4. FIG. 6 illustrates a processing procedure on the storage device 1 side.

If the setting of a flag in a record of a number m (m=0, 1, 2, . . . , n) is to be changed, the authentication process execution module 23 of the host device 2 firstly transmits a password corresponding to the record number m to the storage device 1, and makes a request to execute the authentication process for an access to the record #m. The process is the same as the process firstly executed in the above password change operation.

If receiving the password (p) corresponding to the record number m (#m) from the host device 2 (Step S21), the storage device 1 starts the authentication process. In other words, the authentication process execution module 14 of the storage device 1 checks whether or not a password PWm registered in the record #m agrees with the password p received in the above Step S21 (Step S22). The processes thus far performed by the storage device 1 (Steps S21 and S22) and a process in the case of “PWm≠p” (Step S25) are the same as those in Steps S11, S12 and S15 of the above password change operation.

If “PWm=p” (Step S22: Yes), the authentication process execution module 14 notifies the host device 2 of the fact as authentication success. In the host device 2 that has received the notification that authentication was successful, the security setting module 24 instructs the storage device 1 to change the setting of the flag in the record #m. In other words, the security setting module 24 issues an instruction to enable (or disable) an encryption key registered in this record. In the storage device 1 that has received the instruction to enable (or the instruction to disable) the encryption key from the host device 2, the security setting module 15 changes the setting of the flag in accordance with the instruction content (Steps S23 and S24). Specifically, if the encryption key is instructed to be enabled, the corresponding flag Fm is set to “1”. If the encryption key is instructed to be disabled, the corresponding flag Fm is set to “0”.

The host device 2 may not transmit an instruction to change the setting of a flag after authentication is successful, but may transmit the change instruction together with an existing password for authentication to change the setting of a flag if authentication is successful.

When starting the operation of writing a file to the storage device 1 and when reading a file from the storage device 1, the host device 2 makes a flag setting change for enabling an encryption key. Moreover, after the file write operation is complete, and after the file read operation is complete, a flag setting change for disabling an encryption key is made. A flag setting change for enabling an encryption key is made immediately before file writing/reading is started, and a flag setting change for disabling an encryption key is made immediately after file writing/reading is complete; accordingly, it is possible to realize a system where security is improved. Moreover, a flag setting change for disabling an encryption key may be made, not initiated by the host device 2, but autonomously by the storage device 1 at a predetermined timing after the file writing/reading is complete.

### <File Write/Read Operation>

A description will be given on the host device 2's operation of writing a file to the storage device 1 and the host device 2's operation of reading a file from the storage device 1.

FIG. 7 is a view illustrating a configuration example of a write command issued when the host device 2 requests the storage device 1 to write a file. As illustrated, in the information processing system of the embodiment, the host device 2 instructs the storage device 1 to write a file by use of a write command including the “key number” that is information indicating an encryption key used in the file encryption process. Here, a record number (“No.” shown in FIG. 4) of a record where an encryption key is registered is set to be a key number. The value set in byte 0 (0x2A) is the information (command type) that indicates a write command. The “logical block address” allocated to bytes 2 to 5 indicates the start address of an area to store a file. The “transfer block length” allocated to bytes 7 to 8 indicates the information length (size) of a file.

Moreover, although the illustration is omitted, the key number is included also in a read command issued when the host device 2 makes a request to output (read) a file stored in the storage device 1. A read command is configured to set a value that indicates a read command for the command type in byte 0 of the write command (refer to FIG. 7). In the case of a read command, the “logical block address” indicates the start address of an area to store a file to be read. The “transfer block length” indicates the information length of a file to be read. The “key number” indicates an encryption key used for the process of decrypting a file stored in an area designated by the logical block address and the transfer block length.

The configurations of a write command and a read command are not limited to the above configurations. Although the key number is allocated to byte 9 in FIG. 7, it may be allocated to a byte other than byte 9.

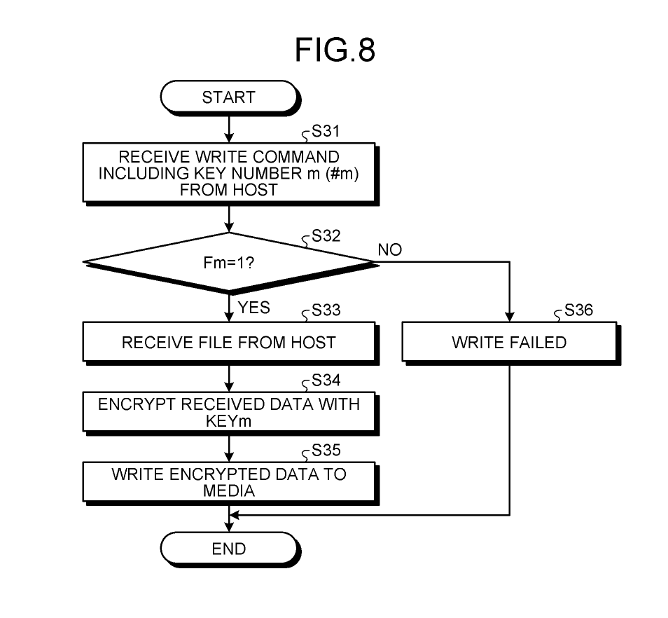

FIG. 8 is a flowchart illustrating an example of a file write procedure. If a file is written to the storage device 1, in the data processing module 21 of the host device 2, the command issuance module 211 firstly issues a write command where the logical block address and the transfer block length are set, and then the key number addition module 212 adds a key number (assuming #m) to the write command issued by the command issuance module 211 to transmit the write command to the storage device 1. The operation of enabling an encryption key (refer to FIG. 6) is executed before the write command is transmitted.

In the storage device 1, the command processing module 122 in the media controller 12 analyzes the command received from the host device 2. If it is judged to have received a write command including a key number, the key table stored in the storage media 11 is referred to via the media access module 121, and a flag in a record indicated by a key number included in the received write command is checked (Steps S31 and S32). If the flag is in a state of permitting the use of the encryption key (Fm=1) as a result of the check (Step S32: Yes), the host device 2 is permitted to transmit a file. In response to this, the data transmission and receipt module 214 of the host device 2 transmits the file corresponding to the above write command to the storage device 1. After the transmission is complete, the transmitted file is associated with the key number used for the process of encrypting this file (the key number set for the above write command) to register them in the correspondence table of the file and the key number, the correspondence table being a table held by the table holding module 213.

After receiving the file from the host device 2, in the media controller 12 in the storage device 1, the encryption processing module 123 encrypts the received file by use of the encryption key (KEYm) corresponding to the key number included in the write command received in Step S31 (Steps S33 and S34). After the encryption process is complete, the media access module 121 receives the encrypted data that is the encrypted file, and writes to the user data storage area 111 of the storage media 11 (Step S35).

On the other hand, in the above Step S32, if the flag is in a state that indicates non-permission to use the encryption key (Fm≠1) (Step S32: No), the operation is terminated as file write failure (write failure) (Step S36).

If a write command without a key number is received, the operation may be terminated as write failure, or the file may not be encrypted and may be written as it is to the user data storage area 111 of the storage media 11. If the operation is set to be terminated as write failure, all files stored in the storage device 1 turn to encrypted data; accordingly, it is possible to keep the possibility of a leak of stored information low. On the other hand, if the file is set to be stored without being encrypted, it is made possible for a host device that cannot issue a special write command including an encryption key to use the storage device 1, and therefore it is possible to maintain a function of preventing a leak of information and improve versatility. In addition, it is made possible for a host device that can issue a command including an encryption key to use the storage device 1 in a manner of causing information with high importance to be encrypted and stored, and information with low importance to be stored without being encrypted. As a result, it is possible to keep increases in a processing load, a processing delay, and the like to a minimum necessary in the storage device 1.

After file writing is complete, the host device 2 executes the operation of disabling an encryption key (refer to FIG. 6).

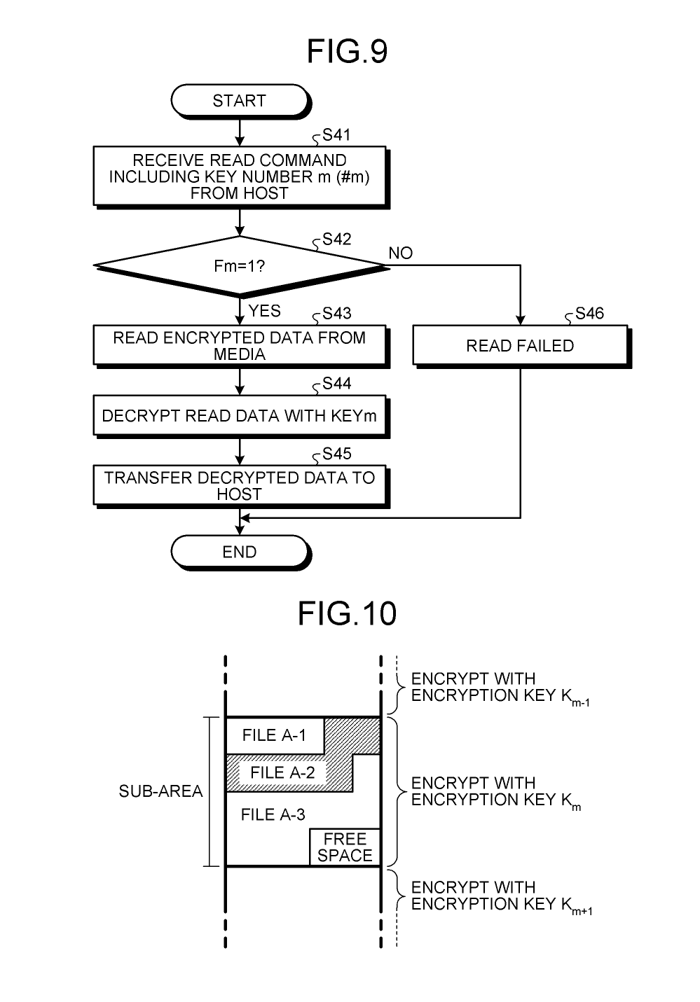

FIG. 9 is a flowchart illustrating an example of a file read procedure. If a file is read from the storage device 1, in the data processing module 21 of the host device 2, the command issuance module 211 firstly issues a read command where the logical block address and the transfer block length are set. If the command issued by the command issuance module 211 is a read command, the key number addition module 212 refers to the table held by the table holding module 213, and adds a key number (assuming #m) to the read command to transmit the read command to the storage device 1. The key number added to the read command is set to be the same as the key number designated by the write command upon writing a file to be read. The operation of enabling an encryption key (refer to FIG. 6) is executed before the read command is transmitted.

In the storage device 1, the command processing module 122 in the media controller 12 analyzes the command received from the host device 2. If it is judged to have received a read command including a key number, the key table stored in the storage media 11 is referred to via the media access module 121, and a flag in a record indicated by the key number included in the received read command is checked (Steps S41 and S42). If the flag is in a state of permitting the use of the encryption key (Fm=1) as a result of the check (Step S42: Yes), the media access module 121 reads the encrypted data from an area designated by the read command (Step S43). Next, the encryption processing module 123 decrypts the encrypted data by use of the encryption key KEYm designated by the read command (Step S44), and transfers the data to the host device 2 via the data transmission and receipt module 124 (Step S45).

On the other hand, in the above Step S42, if the flag is in a state indicating non-permission to use the encryption key (Fm≠1) (Step S42: No), the operation is terminated as file read failure (read failure) (Step S46).

If a read command without a key number is received, the operation may be terminated as read failure, or the designated file may be transferred as it is without decryption. However, which operation to be selected depends on the operation of when a write command without a key number is received. In other words, if it is set to write failure when a write command without a key number is received, the operation is terminated as read failure when a read command without a key number is received. In this case, it is possible to improve security of information by restricting an unauthorized access by a host device that cannot issue a special write command including an encryption key. On the other hand, if a file is stored without encryption when a write command without a key number is received, a file is transferred as it is without decryption when a read command without a key number is received. In this case, it is possible to improve versatility and keep increases in a processing load, a processing delay, and the like, in the encryption and decryption processes to a minimum necessary.

In this manner, in the information processing system of the embodiment, the storage device 1 holds the key table in which a plurality of records is registered, the records including encryption keys used for the encryption process at the time of file writing and the decryption process at the time of file reading, numbers indicating the encryption keys (key numbers), flags indicating whether or not the encryption keys can be used, and passwords used for the authentication process of a host device. Moreover, if receiving a write command or a read command that includes a key number, the storage device 1 checks the state of a flag corresponding to the key number. If the flag is in a state indicating permission to use an encryption key, the storage device 1 encrypts or decrypts a file by use of the encryption key indicated by the key number. Moreover, the setting of a flag is changed after receipt of the instruction from the host device 2 that was successful in authentication that used a password associated with each flag. Therefore, it is possible to realize the storage device that encrypts and stores files using a plurality of encryption keys properly without decreasing efficiency in use of the storage area.

For example, if it is configured, as shown in FIG. 10, that the storage area is divided into a plurality of sub-areas and a plurality of encryption keys is used by allocating an encryption key individually to each of the plurality of sub-areas, even if there exists free space (an unused area) in a certain sub-area, the size of a file that can be stored in the area is limited; therefore the free space may be left unused. On the other hand, the storage area is not divided into a plurality of sub-areas in the storage device of the embodiment; accordingly, efficiency in use of the storage area does not decrease. Moreover, file writing that causes less fragmentation becomes possible; accordingly, it can be expected to improve the performance of data transfer.

Moreover, according to the storage device of the embodiment, it is possible to improve security of stored information more than before. For example, when an attacker attempts to read a file, if he/she does not know a key number designated by a write command at the time of writing, he/she cannot read the file correctly. Since it is possible to prohibit the use of an encryption key by a flag indicating whether or not the encryption key can be used, even if an attacker changes and uses the encryption key by a brute force attack, decryption is not performed and therefore it is not possible to read the correct file.

The system may be one in which an encryption key registered in a specific record (for example, assuming a record of the number #0) of the key table (refer to FIG. 4) can always be used without password authentication so as to allow anyone to use the encryption key. Moreover, the storage media 11 may not hold the key table, but the media controller 12 or the like may hold the key table.

### Second Embodiment

A description will be given on a second embodiment. The configuration of an information processing system is similar to that of the first embodiment. Moreover, the configurations of a storage device and a host device are similar to those in the first embodiment (refer to FIGS. 1 to 3).

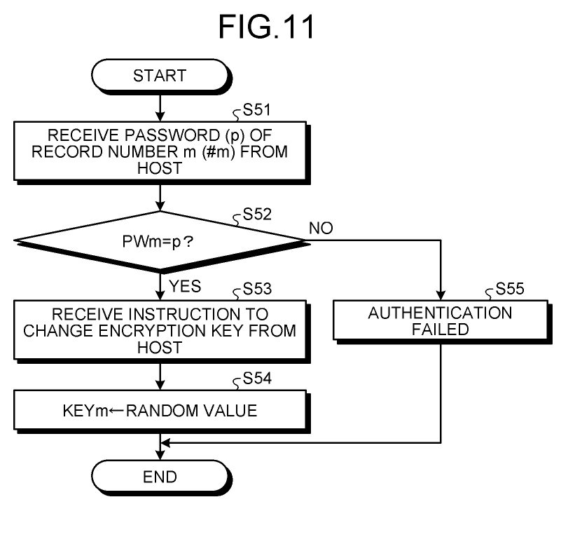

FIG. 11 is a flowchart illustrating an example of a procedure for changing an encryption key registered in a predetermined record in the key table shown in FIG. 4. Although the details will be described later, the information processing system of the embodiment erases a file stored in the storage device 1 by changing an encryption key registered in the key table.

If an encryption key registered in a record of a number m (m=0, 1, 2, . . . , n) is to be changed, the authentication process execution module 23 of the host device 2 firstly transmits a password corresponding to the record number m to the storage device 1, and makes a request to execute authentication process for an access to the record #m. The process is the same as the process firstly executed in the password change operation described in the first embodiment.

If receiving a password (p) corresponding to the record number m (#m) from the host device 2 (Step S51), the storage device 1 starts the authentication process. In other words, the security setting module 15 of the storage device 1 checks whether or not a password PWm registered in the record #m agrees with the password p received in the above Step S51 (Step S52). The processes thus far performed by the storage device 1 (Steps S51 and S52) and a process in the case of “PWm≠p” (Step S55) are the same as those in Steps S11, S12 and S15 of the password change operation described in the first embodiment.

If “PWm=p” (Step S52: Yes), the encryption key change module 16 notifies the host device 2 of the fact as authentication success. In the host device 2 that has received the notification that authentication was successful, the encryption key change module 25 instructs the storage device 1 to change an encryption key registered in the record #m. In the storage device 1 that has received the instruction to change the encryption key from the host device 2, the encryption key change module 16 changes the encryption key registered in the record #m. For example, the encryption key is changed by generating a random number by a predetermined method to overwrite the existing encryption key (Steps S53 and 54).

The host device 2 may not transmit the instruction to change an encryption key after authentication is successful, but may transmit a change instruction together with an existing password for authentication to change the encryption key if authentication is successful.

### <File Erasure>

If the storage device 1 stores a file encrypted by use of an encryption key KEYm registered in the record #m in the key table, the host device 2 issues an instruction to change the encryption key KEYm registered in the record #m to erase the file. If the encryption key is changed, it becomes impossible to decrypt the file encrypted by use of the encryption key before the change and it becomes impossible to read the file (the file before encrypted). Therefore, it becomes possible to erase a specific file by designating an encryption key specific to each file and storing the encryption key in the storage device 1. If erasing a file, the host device 2 updates a table that indicates a corresponding relationship between the file and the encryption key.

After an encryption key is changed and then erasure is performed, if a relevant file is read, a data row having no meaning is transferred from the storage device 1; however, it is possible to check whether or not the erasure has been performed correctly by previously adding information for check such as a checksum or CRC to the file in a state of plain text. In other words, after an encryption key is changed and then erasure is performed, a file is read from a relevant area to check whether or not information for check added thereto is changed; accordingly, it is possible to know whether or not the erasure has been performed correctly.

### <File Moving>

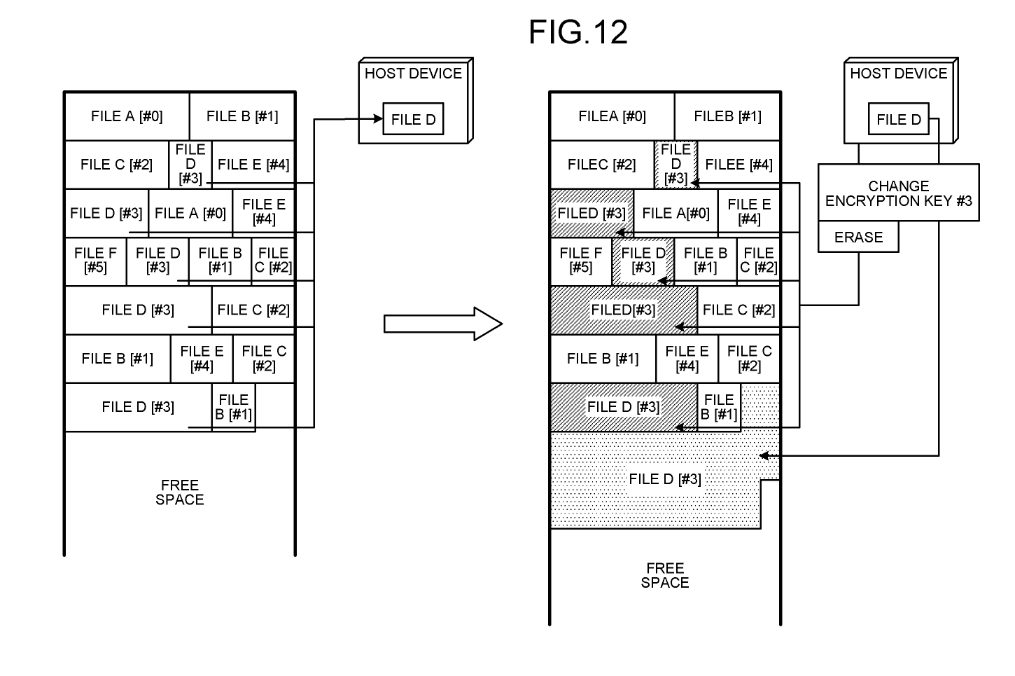

FIG. 12 is a view illustrating an example of the operation of moving a file in the storage media 11 of the storage device 1. More specifically, illustrated is the operation of integrating a fragmented file by defragmentation among files A to E stored in the storage media 11 in a state of being encrypted with an encryption key specific to each file. The files A to E are assumed to be encrypted with encryption keys of key numbers 0 (#0) to 4 (#4), respectively. It is assumed that the storage device 1 does not recognize which file is encrypted with which encryption key. Therefore, the storage device 1 does not hold information on the corresponding relationship between a file and an encryption key; accordingly, there will be no leaks of information on the corresponding relationship due to an unauthorized access and thus it is possible to maintain a high level of security of a file.

For example, if the file D encrypted with the encryption key of the key number [#3] is moved as shown in FIG. 12, the host device 2 firstly reads all parts of the file D from the storage device 1 to combine them, and then instructs the storage device 1 to change the encryption key of the key number [#3] and erases the fragmented file D. After the file erasure by changing the encryption key is complete, the storage device 1 is instructed to rewrite the file D that has been read out. At this point, a logical block address (write area) is set in the write command to prevent the file D from being fragmented. The encryption key used for encryption at the time of rewriting is the encryption key of the key number [#3] (the encryption key changed for the file erasure) in FIG. 12; however, another encryption key may be designated. If a key number of an encryption key used for decryption upon reading a file is different from a key number of an encryption key used for encryption upon rewriting, the host device 2 updates the information (the table that indicates the corresponding relationship between the file and the encryption key) held by the table holding module 213. On the other hand, if a key number upon reading a file is the same as a key number upon rewriting, it is not necessary to update the information held by the table holding module 213.

Defragmentation may be performed by the storage device 1 alone without involving the host device 2. In that case, the media controller 12 and the encryption key change module 16 cooperate to sequentially perform the reading of a fragmented file, a change of an encryption key, and the rewriting of the file.

In this manner, in the information processing system of the embodiment, the storage device 1 changes an encryption key used for the encryption and decryption processes in response to an instruction from the host device 2; accordingly, the host device 2 can select a part of the files stored in the storage device 1 to erase it by instructing a change of an encryption key. Moreover, an encryption key is changed to erase a file; accordingly, even if the size of the file is big, it is possible to securely erase it in a short period of time.

### Third Embodiment

A host device may decide which encryption key to use in accordance with the degree of importance of various types of information (files) stored in a storage device. For example, an encryption key of a larger key number is associated so as to be used for encryption of a file with a higher degree of importance, and a specific user can use an encryption key of a large key number among users who use the host device. Specifically, a specific user is notified of a password (authentication password) necessary when using (designating) an encryption key. The notification scope of the authentication password is limited in accordance with the corresponding degree of importance. In other words, as the authentication password has a higher degree of importance, the notification scope is narrowed (the number of notified users becomes less).

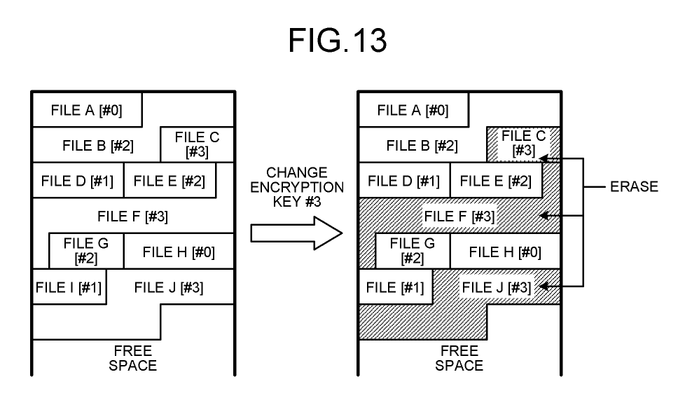

A description will be given on a specific example with reference to FIG. 13. FIG. 13 is a view illustrating an example of a file erasure operation, and illustrates an operation example of when a part of the files is erased from a state where a file A to a file J are stored in the storage media 11 of the storage device 1. It is assumed that the files A and H have been encrypted with an encryption key of a key number [#0], the files B, E and G have been encrypted with an encryption key of a key number [#2], and the files C, F and J have been encrypted with an encryption key of a key number [#3]. Moreover, it is assumed that the files encrypted with the encryption key of the key number [#3] have the highest degree of importance. In this case, the host device instructs the storage device to change the encryption key of the key number [#3]; accordingly, it is possible to simultaneously erase the files C, F and J encrypted with the encryption key #3 before the change. For example, if one wishes to erase files with the highest degree of importance due an emergency such as a change in server operation or an attack from the outside, the encryption key of the key number [#3] is changed; accordingly, it is possible to easily erase even a file scattered in the storage device, and there is no influence at all on the other files.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A storage device comprising:
a storage module configured to store an encryption key, a flag indicating whether the encryption key can be used, a password configured to be used for authentication associated with the encryption key and the flag, and user data;
an authentication process execution module configured to authenticate a connected host device by using the password;
an encryption processor configured to encrypt user data received from the host device or to decrypt the user data stored in the storage module, by using an encryption key stored and being associated with a flag indicating permission to use the encryption key, in accordance with an instruction from the host device that is successful in the authentication; and
a security setting module configured to change a setting of the flag stored and being associated with the encryption key used for the encryption or the decryption, on performing the encryption or the decryption.

2. The storage device of claim 1, wherein on receiving a write command including a key number that is information to designate an encryption key,
the encryption processor is configured to encrypt user data designated by the write command by using an encryption key designated by the key number in a case where a flag associated with the encryption key designated by the key number indicates permission to use the encryption key, and
the storage module is configured to store the user data encrypted by the encryption processor.

3. The storage device of claim 1, wherein
the encryption processor is configured to decrypt user data designated by a read command by using an encryption key designated by a key number in a case where a flag associated with the encryption key designated by the key number indicates permission to use the encryption key on receiving the read command including the key number that is information to designate the encryption key.

4. The storage device of claim 2, wherein
the encryption processor is configured to decrypt user data designated by a read command by using an encryption key designated by a key number in a case where a flag associated with the encryption key designated by the key number indicates permission to use the encryption key on receiving the read command including the key number that is information to designate the encryption key.

5. The storage device of claim 1, wherein the security setting module is configured to change the setting to a state where the flag associated with the encryption key used for the encryption or the decryption indicates permission to use the encryption key before the encryption is performed and the decryption is performed, and to change the setting to a state where the flag indicates non-permission to use the encryption key after the encryption or the decryption is performed.

6. The storage device of claim 4, wherein the security setting module is configured to change the setting to a state where the flag associated with the encryption key used for the encryption or the decryption indicates permission to use the encryption key before the encryption is performed and the decryption is performed, and to change the setting to a state where the flag indicates non-permission to use the encryption key after the encryption or the decryption is performed.

7. The storage device of claim 1, wherein a designated encryption key is overwritten with a random number to update the encryption key on receiving an instruction to change the encryption key from the host device that is successful in authentication.

8. A host device using a storage device storing an encryption key, a flag indicating whether the encryption key can be used, a password configured to be used for authentication associated with the encryption key and the flag, and user data after encryption by using an encryption key stored and being associated with a flag indicating permission to use the encryption key, the host device comprising:
a command issuance module configured to issue a write command transmitted on writing user data to the storage device and a read command transmitted on reading user data from the storage device; and
a key number addition module configured to add a key number that is information to designate an encryption key used on encrypting user data to be written to the write command issued from the command issuance module, and to add a key number designating an encryption key used on decrypting user data to be read to the read command issued by the command issuance module,
wherein the key number added by the key number addition module to the write command and written user data are associated with each other and stored.

9. The host device of claim 8, further comprising:
a security setting module configured to instruct the storage device to bring a flag associated with an encryption key designated by the key number added to the write command to a state indicating permission to use the encryption key before the write command is issued, and to instruct the storage device to bring the flag to a state indicating non-permission to use the encryption key after user data corresponding to the write command is finished to be written.

10. The host device of claim 8, further comprising:
a security setting module configured to instruct the storage device to bring a flag associated with an encryption key designated by the key number added to the read command to a state indicating permission to use the encryption key before the read command is issued, and to instruct the storage device to bring the flag to a state indicating non-permission to use the encryption key after user data corresponding to the read command is finished to be read.

11. The host device of claim 9, wherein the security setting module is configured to instruct the storage device to bring a flag associated with an encryption key designated by the key number added to the read command to a state indicating permission to use the encryption key before the read command is issued, and to instruct the storage device to bring the flag to a state indicating non-permission to use the encryption key after user data corresponding to the read command is finished to be read.

12. The host device of claim 8, further comprising:
an encryption key change module configured to instruct the storage device to overwrite an encryption key associated with user data to be erased with a random number and change the encryption key.

13. An information processing method executed in an information processing system including: a storage device storing an encryption key, a flag indicating whether or not the encryption key can be used, a password used for authentication associated with the encryption key and the flag and user data encrypted by using any one of the stored encryption keys; and a host device using the storage device, the information processing method comprising:
authenticating the host device based on the password;
instructing the storage device to set the flag to a state indicating permission to use an encryption key by the host device that is successful in authentication in the authenticating;
executing by the host device a process of issuing a write command including information of an encryption key associated with a flag indicating permission to use the encryption key to cause the storage device to store user data or a process of issuing a read command including information of an encryption key associated with a flag indicating permission to use the encryption key to read user data from the storage device; and
instructing the storage device to restore the flag associated with the encryption key used in the executing to a state indicating non-permission to use the encryption key.

14. The information processing method of claim 13, wherein the storage device is configured to encrypt user data by using the encryption key designated by the write command, and to store the user data in an encrypted state on receiving the write command.

15. The information processing method of claim 13, wherein the storage device is configured to decrypt user data stored in an encrypted state by using the encryption key designated by the read command on receiving the read command.

16. The information processing method of claim 14, wherein the storage device is configured to decrypt user data stored in an encrypted state by using the encryption key designated by the read command on receiving the read command.

17. The information processing method of claim 13, wherein the host device is configured to instruct the storage device to set the flag to a state indicating permission to use the encryption key before the process of issuing the write command and the process of issuing the read command, and to instruct the storage device to set the flag to a state indicating non-permission to use the encryption key after storing user data to the storage device or reading user data from the storage device.

18. The information processing method of claim 16, wherein the host device is configured to instruct the storage device to set the flag to a state indicating permission to use the encryption key before the process of issuing the write command and the process of issuing the read command, and to instruct the storage device to set the flag to a state indicating non-permission to use the encryption key after storing user data to the storage device or reading user data from the storage device.

19. The information processing method of claim 13, further comprising:
instructing the storage device by the host device that is successful in authentication in the authenticating to overwrite the encryption key associated with the password used in the authenticating with a random number and preventing user data encrypted by using the encryption key before overwritten with the random number from being decrypted.
